(19) United States
(12) Patent Application Publication
(10) Pub. No.: US 2015/0180051 A1
(43) Pub. Date: Jun. 25, 2015

(54) Fuel Cell Module for a Vehicle

(71) Applicant: Daimler AG, Stuttgart (DE)

(72) Inventors: Felix Blank, Konstanz (DE); Simon Hollnaicher, Albershausen (DE); Martin Keuerleber, Stuttgart (DE); Jan Martinec, Prag (CZ); Cosimo Mazzotta, Ulm (DE); Uwe Pfister, Winnenden (DE); Michael Procter, North Vancouver (CA); Pavel Sarkady, Prag (CZ); Wolfgang Schmid, Illerkirchberg (DE); Holger Stark, Allmersbach im Tal (DE)

(21) Appl. No.: 14/390,482

(22) PCT Filed: Mar. 27, 2013
(86) PCT No.: PCT/EP2013/000926

§ 371 Date: Oct. 3, 2014

(30) Foreign Application Priority Data
Apr. 5, 2012 (DE) 10 2012 007 055.1

(51) Int. Cl. H01M 8/02; H01M 8/04

(52) U.S. Cl. CPC H01M 8/02; H01M 8/04126; H01M 8/04007; H01M 8/04201; H01M 8/04156; H01M 2250/20

(57) ABSTRACT

A fuel cell module includes at least one fuel cell stack with a housing. The at least one fuel cell stack is arranged, with a plurality of system components for conducting and/or conditioning the fluids for the supply of the at least one fuel cell stack, with a mechanical interface for fastening the fuel cell module to the vehicle. The mechanical interface is arranged on the housing, wherein the housing forms a carrier for the system components.

### BACKGROUND AND SUMMARY OF THE INVENTION

Exemplary embodiments of the invention relate to a fuel cell module for a vehicle with at least one fuel cell stack, with a housing in which the at least one fuel cell stack is arranged, with a plurality of system components for conducting and/or conditioning fluids for the supply of the at least one fuel cell stack and with a mechanical interface for fastening the fuel cell module to the vehicle, wherein the mechanical interface is arranged on the housing.

Fuel cell systems are known in stationary and mobile applications. They serve to produce and provide electrical energy in an electrochemical process from chemical energy from a fuel, mainly hydrogen. The fuel cell systems comprise mainly a plurality of fuel cells, wherein each fuel cell has an anode and a cathode region, which are separated from one another by a membrane, in particular a proton-conducting membrane, and wherein the actual electrochemical process takes place in the fuel cells.

In the mobile applications, the use of the fuel cell system to generate drive energy for vehicles is of particular interest. This concept provides the possibility to generate electrical energy for the drive of the vehicle locally and according to need, and in this way to avoid losses in the storage of electrical energy. Fuel cell systems mainly produce water as their reaction product, such that there is no, or only very little, environmental damage during the operation of the fuel cell systems.

In order to increase the suitability for daily use of fuel cell systems, the installation situation of the fuel cell systems in the vehicle is to be considered.

For example, German patent document DE 10 2004 047 944 A1 discloses a fuel cell system wherein the supply and discharge lines for fluids of the fuel cell system are only arranged on one side so as to diminish the pipeline structure, reduce the number of components and simplify the mounting process.

Exemplary embodiments of the present invention are directed to a fuel cell module for a vehicle, which enables simple integration into the vehicle.

Exemplary embodiments of the invention thus relate to a fuel cell module that is suited and/or designed for a vehicle. In particular, the fuel cell module is designed to provide electrical energy as drive energy for the vehicle. The vehicle is, in particular, a motor vehicle, specifically a personal automobile or a heavy-goods vehicle.

The fuel cell module comprises at least one fuel cell stack. It is preferable for the fuel cell module, for constructive purposes, to have exactly one fuel cell stack, whereas in modified embodiments, the fuel cell module can also comprise two or more fuel cell stacks. A plurality of fuel cells is arranged in the fuel cell stack, which each have a cathode and an anode region, which are separated from one another by a membrane, in particular by a proton-conducting membrane. The fuel cells are designed as plates and are arranged in a stack direction in the fuel cell stack. For example, more than 50 or 100 fuel cells are arranged in one fuel cell stack.

The fuel cell module comprises a housing, in which the at least one fuel cell stack is arranged. The housing is, in particular, designed to be close to the surroundings, such that the fuel cell stack is arranged in the housing as resistant to dust and/or moisture. In particular, the housing is in accordance with at least IP54 or better. The housing encloses the fuel cell stack and is designed roughly as a cuboid, for example.

The fuel cell module comprises a plurality of system components for conducting and/or conditioning fluids, which are required for the supply of the at least one fuel cell stack in operation. The fuel, specifically hydrogen, the oxidant, specifically atmospheric air, and/or a coolant for the tempering the fuel cell module or fuel cell stack are to be cited in particular as fluids. The coolant is preferably designed as de-ionised water. The de-ionised water can be produced, for example, by feeding water through an ion exchanger.

The fuel cell module comprises a mechanical interface for fastening the fuel cell module to the vehicle, wherein the mechanical interface is arranged on the housing. The mechanical interface can consist of several interface sections. In particular, one side of the mechanical interface or one of the interface sections is/can be fastened to the housing and the other side to the vehicle. The fuel cell module is fixed in the vehicle via the mechanical interface. It is particularly preferred for at least 80%, preferably at least 90% and in particular at least 95% of the weight of the fuel cell module to be removed via the mechanical interface.

Within the scope of the invention, it is proposed that the housing form a carrier for the system components. Thus, the system components are/can be also fastened to the vehicle via the mechanical interface. A power flow for supporting the system components thus runs serially from the respective system component, via the housing, into the mechanical interface to the housing. The housing is, from the point of view of the power flow, thus arranged between the mechanical interface and the system components.

The advantage of the invention is to ensure that the mounting or an exchange of the fuel cell module in the vehicle can be considerably simplified. Since the system components are typically fastened to the vehicle independent of the housing, both the system components and the housing with the fuel cell stack must be detached from the vehicle for the demounting of the fuel cell module. This procedure implies that even the delicate connections between the system components and the housing or the fuel cell stack are either to be detached, if first the fuel cell stack is dismantled and then the system components are to be demounted, or at least be loaded, if first the system components are separated from the vehicle and only connected to the housing via the supply line to the fuel cell stack, which is delicate according to the invention.

By contrast, the invention proposes that the fuel cell module be embodied as a constructional unit, wherein the system components are fastened to the housing and the housing, including the system components, is fastened to the vehicle via the mechanical interface. Thus only the mechanical interface must still be detached for the exchange, construction or dismantling of the fuel cell module. Thus the fuel cell module is considerably easier to repair and maintain than in typical constructions.

In a preferred development of the invention, the fuel cell module comprises a fluidic interface for coupling lines for the fluids, and an electrical interface for coupling lines for the generated electrical energy and, in addition, optionally for control signals. These interfaces are necessary for the operation of the fuel cell module.

The fluidic interface comprises at least one line for the fuel and can optionally, in addition, comprise lines for the oxidant and/or the coolant. The electrical interface comprises the lines for conducting the generated electrical energy from the fuel cell module to the loads and, optionally, for the control signals in addition, wherein these can also be transferred without wires.

The system components can be coupled to the mechanical interface via the housing in such a way that the fuel cell module has no connections after the separation of the fluidic, electrical and mechanical interface. In particular, the fuel cell module can be lifted out of the vehicle after separation of these three interfaces. Thus, the invention provides the possibility to mount or exchange a fuel cell module in a vehicle in a fast and defect-free manner.

In a preferred constructive embodiment of the invention, the housing comprises at least one housing body and at least one end plate, which closes the housing body at its front side. Provision is made for the at least one end plate to form the carrier for the system components. It is particularly preferred for the fluids to be conducted to the fuel cell stack through the at least one end plate, such that this must have corresponding outlets. Due to the fact that the system components are fitted onto the at least one end plate as carriers, the connection between the system components and the fuel cell stack can be kept very short and, in particular, implemented in a fixed and/or tight manner, such that leakages etc. do not Occur.

In a preferred development of the invention, the mechanical interface is arranged on the at least one end plate. Thus, as well as the carrier function for the system components, the at least one end plate also takes on the carrier function for the mechanical interface, such that a designated region in the fuel cell module can be designed correspondingly in a mechanically resilient manner.

In a potential embodiment of the invention, the housing has two end plates, wherein the system components and/or mechanical interface are separated onto the two end plates. For purposes of construction space, it has proved to be advantageous if the system components are separated on two sides of the fuel cell module. In order to be able to mount the fuel cell module securely in the vehicle, in particular without provoking tipping, it is advantageous for the mechanical interface to also be separated onto the two end plates.

In a practical embodiment of the invention, the at least one end plate is designed as a cathode plate, which bears the system components for oxidant supply. In particular, the cathode plate bears an oxidant humidifier, which humidifies the oxidant with water, an oxidant humidifier bypass, which enables the oxidant to be circumvented at the oxidant humidifier, and/or an oxidant heater, which serves to pre-heat the oxidant, in particular during a cold-start of the fuel cell module.

In a potential development of the invention or an alternative thereto, the at least one end plate is designed as an anode plate, which bears the system components for the fuel and/or coolant. In this case, the system components comprise a recirculation fan, which feeds a partially consumed fuel from the fuel cell stack to the fuel cell stack and, if necessary, mixes with fresh fuel, a water separator, which enables water produced by the electrochemical reaction to discharge from the recirculated fuel, and/or a coolant heater, which is designed to temper the coolant during a cold-start of the fuel cell module.

It is particularly preferable for the fuel cell module to have a previously-described cathode plate as the first end plate and a previously-described anode plate as the second end plate in the housing.

It is preferable for the channel end plate to be designed as a material hybrid, wherein a carrier structure made from a first material and a functional support on the carrier structure made from a second material are designed. For example, the first material is designed as a fiber composite or as a metallic material in order to achieve a sufficient level of mechanical rigidity. The second material is preferably designed as a synthetic material, such that this, according to application, can form a sealing from the housing, insulation from the coolant, a chemically neutral environment for the oxidant or fuel or electrical insulation for the stack. It is particularly preferred for the end plate to be designed in such a way that the functional support forms a sealing between the channel end plate and the housing.

### BRIEF DESCRIPTION OF THE DRAWING FIGURE

Further features, advantages and effects of the invention arise from the description of a preferred exemplary embodiment below, as well as from the appended figures. Here are shown:

FIG. 1 a schematic top view of a fuel cell module as an exemplary embodiment of the invention.

### DETAILED DESCRIPTION

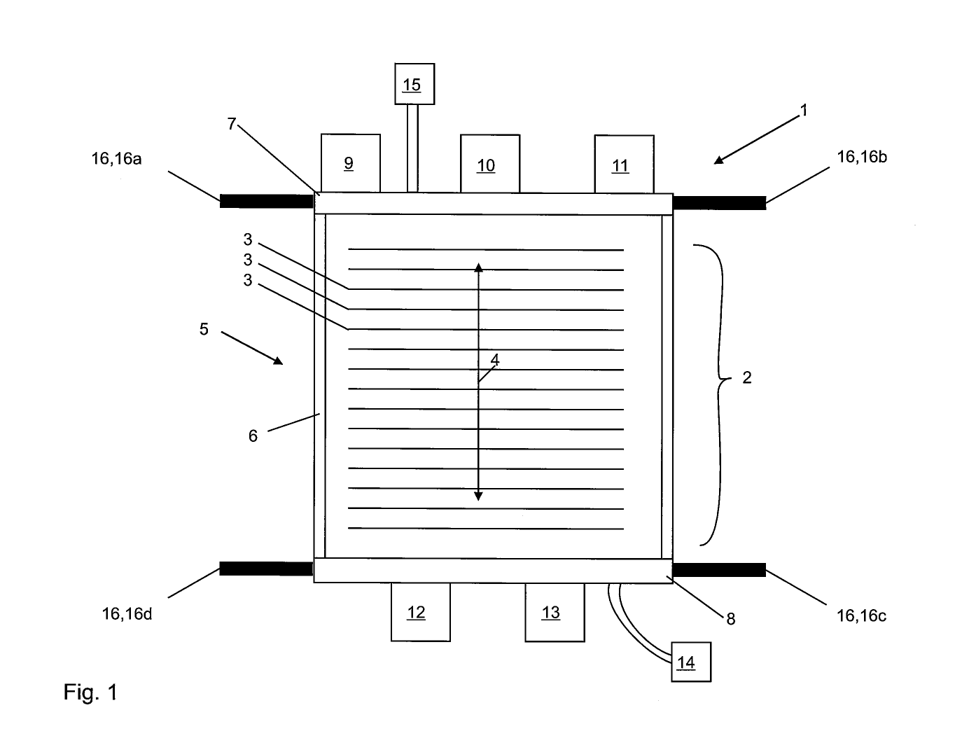

In a schematic top view, FIG. 1 shows a fuel cell module 1 for a vehicle, which is designed to generate the drive energy of the vehicle. The vehicle is, for example, a personal automobile.

The fuel cell module 1 comprises a schematically depicted fuel cell stack 2, which is constructed from a plurality of fuel cells 3, which are arranged in a stack direction 4. There are, for example, more than 50 or 100 such fuel cells located in the fuel cell stack 2.

The fuel cell stack 2 is protected from the outside by a housing 5, which has a housing body 6 and an anode plate 7 and a cathode plate 8. The anode plate 7 and the cathode plate 8 are end plates that are arranged frontally in the stack direction 4 to the fuel cell stack 2. The housing body 6 is designed, for example, as a sheet jacket in the form of a sleeve that rotates in the stack direction 4 with a rectangular cross-section. The housing body 6, the anode plate 7 and the cathode plate 8 together form the housing 5, in order to protect the fuel cell stack 2 from dust and moisture.

Several system components are arranged on the anode plate 7 for conducting and/or conditioning the fuel. The system components cited below are directly connected, for example, bolted, to the anode plate 7. This has the advantage that long pipeworks between the anode plate 7 and the system components can be dispensed with, such that susceptibility to defects of the fuel cell module 1 can be reduced.

A first system component is a recirculation fan 9, which is designed to accelerate partially consumed fuel in a recirculation branch from an outlet of the fuel cell stack 2 and to transport it to an inlet of the fuel cell stack 2. A second potential system component is a water separator 10, which is designed to discharge water from the partially consumed fuel in the cited recirculation branch.

A further potential system component is a mixing valve 11, which is designed to mix partially consumed fuel from the recirculation branch with fresh fuel, before this mixture is introduced into the fuel cell stack 2. Alternatively, the mixing valve can be combined with a jet pump (not depicted). This alternative can replace or be an extension to the recirculation fan 9.

A humidifier 12 is arranged as a first system component on the cathode plate 8, which is designed to humidify the oxidant during water supply, so as to condition this for the fuel cells 3. A second potential system component on the cathode plate 8 is a coolant heater 13, which is designed to temper the coolant for the fuel cell stack 2. The coolant heater 13 can also be arranged on the anode plate 7 in modified exemplary embodiments.

Additionally, the fuel cell module 1 has an electrical interface 14 for discharging the generated electrical energy and, if necessary, for exchanging control signals. Furthermore, the fuel cell module 1 comprises a fluidic interface 15, which is designed to supply fuel, supply and discharge coolant and, optionally, additionally supply the oxidant. Alternatively, the fuel cell module 1 comprises two fluidic interfaces 15, each on the anode plate 7 and on the cathode plate 8.

In addition, the fuel cell module 1 has a mechanical interface 16, which comprises four interface sections 16a, b, c, d in the exemplary embodiment shown. The number of potential interface sections is unlimited. The interface sections 16a to d are directly connected to the anode plate 7 or the cathode plate 8 and serve to fasten the fuel cell module 1 in the vehicle. Thus, the interface sections 16a to d are fastened to the anode plate 7 or cathode plate 8 at one end, and to the vehicle at the other, free end.

At least 95% of the weight and the loads of the fuel cell module 1 are removed via the mechanical interface 16. The electrical interface 14 and the fluidic interface 15 serve, however, only to provide the fluids or to provide electrical contact. In particular, the system components 9 to 13 are each at least 95% fastened to the anode plate 7 or cathode plate 8 with respect to their weight.

The advantage of the invention is that, for a dismantling, construction or exchange of the fuel cell module 1, only the electrical interface 14, the fluidic interface 15 and the mechanical interface 16 must be detached, and then the fuel cell module 1 can be exchanged.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1. Fuel cell module
2. Fuel cell stack
3. Fuel cells
4. Stack direction
5. Housing
6. Housing body
7. Anode plate
8. Cathode plate
9. Recirculation branch
10. Water separator
11. Mixing valve
12. Oxidant humidifier
13. Coolant heater
14. Electrical interface
15. Fluidic interface
16. Mechanical interface
16a. Interface section
16b. Interface section
16c. Interface section
16d. Interface section

1-8. (canceled)

9. A fuel cell module for a vehicle, the fuel cell module comprising:
at least one fuel cell stack;
a housing, wherein the at least one fuel cell stack is arranged in the housing;
a plurality of system components configured to conduct and/or condition fluids supplied to the at least one fuel cell stack; and
a mechanical interface configured to fasten the fuel cell module to the vehicle, wherein the mechanical interface is arranged on the housing, and the housing forms a carrier for the plurality of system components.

10. The fuel cell module of claim 9, further comprising:
a fluidic interface configured to couple lines for the fluids; and
an electrical interface configured to couple lines for electrical energy generated by the fuel cell module,
wherein the system components are coupled to the mechanical interface via the housing such that the fuel cell module is free of connections after separation of the fluidic, electrical and mechanical interfaces.

11. The fuel cell module of claim 9, wherein the housing comprises a housing body and at least one end plate, which closes the housing body at its front side, wherein the at least one end plate forms the carrier for the system components.

12. The fuel cell module of claim 11, wherein the mechanical interface is arranged on the at least one end plate.

13. The fuel cell module of claim 11, wherein the housing has two end plates, wherein the system components and/or the mechanical interface are separated onto the two end plates.

14. The fuel cell module of claim 11, wherein the at least one end plate is a cathode plate bearing an oxidant humidifier, an oxidant humidifier bypass and/or an oxidant heater as the system components.

15. The fuel cell module of claim 11, wherein the at least one end plate is a cathode plate bearing a recirculation fan, a water separator and/or a coolant heater as the system components.

16. The fuel cell module of claim 11, wherein the at least one end plate is composed as a material hybrid.
